(19) United States
(12) Patent Application Publication
(10) Pub. No.: US 2018/0341115 A1
(43) Pub. Date: Nov. 29, 2018

(54) OPTICAL APPARATUS FOR NEAR-EYES DISPLAY

(71) Applicant: DEQIANG LUO, Shenzhen (CN)

(72) Inventor: DEQIANG LUO, Shenzhen (CN)

(21) Appl. No.: 15/961,890

(22) Filed: Apr. 25, 2018

(30) Foreign Application Priority Data
May 27, 2017 (CN) 201710389409.0

(51) Int. Cl. G02B 27/01

(52) U.S. Cl. CPC G02B 27/0189; G02B 27/0176; G02B 27/0172

(57) ABSTRACT

An optical apparatus for near-eyes display includes a support body, a display screen disposed in the support body, a convex lens, and a reflector reflecting light. The light of the display screen pass through the convex lens and are amplified by the convex lens. The amplified light enters into the reflector and is reflected to human eyes. The convex lens is disposed between the reflector and the display screen. The reflector and the convex lens form a fixed included angle and are not parallel to each other. The reflector and the convex lens are at a same axis position.

### BACKGROUND OF INVENTION

### 1. Field of Invention

The present disclosure relates to the field of smart glasses technology, and more particularly to an optical apparatus for near-eyes display.

### 2. Description of Prior Art

Smart wearable apparatus are gradually becoming popular, and smart glasses with near-eyes display is one of the smart wearable apparatus and is gradually becoming popular because of unique function of the smart glasses with near-eyes display. Many companies successively start research for the smart glasses. As the smart glasses are close to human eyes, optical characteristic requirements of the smart glasses are very high.

In prior art, the near-eyes display has three optical types: first one is a prism reflection type, second one is a free-form surface type, and third one is a waveguide sheet type. The commonality of the three optical types is that image is transmitted in transparent solid, after the image is processed by amplification and reflection (including total reflection), the amplified image enters the human eyes. The three optical types have high requirement for size of the transparent solid and require high-precision optical coating process, so that cost of optical structure is high and yield is low, which is not good at mass production. At the same time, the products made by the three optical types are large in size and weight, and are not suitable for long-term wearing of the smart glasses.

### SUMMARY OF INVENTION

The aim of the present disclosure is to provide an optical apparatus for near-eyes display capable of having low cost, being convenient for mass production, and simplifying production process.

The present disclosure provides an optical apparatus for near-eyes display includes a support body, a display screen disposed in the support body a convex lens, and a reflector reflecting light. The light of the display screen pass through the convex lens and are amplified by the convex lens. The amplified light enters into the reflector and is reflected to human eyes. The convex lens is disposed between the reflector and the display screen. The reflector and the convex lens form a fixed included angle and are not parallel to each other. The reflector and the convex lens are at a same axis position.

Furthermore, the support body comprises a first support body and a second support body, where the first support body and the second support body are bent at an angle. The reflector is disposed on the second support body, and the convex lens and the display screen are disposed in the first support body; the reflector is parallel to the second support body.

Furthermore, the display screen is parallel to the convex lens, and the display screen and the convex lens are perpendicular to the first support body.

Furthermore, a mechanical transmission regulator is disposed between the display screen and the convex lens; the mechanical transmission regulator adjusts distance between the display screen and the convex lens.

Furthermore, an angle regulator is disposed between the first support body and the second support body, and adjusts the angle between the first support body and the second support body.

Furthermore, the first support body comprises a storage box containing the convex lens and the display screen, and a connecting element connected with the second support body. The connecting element and the storage box are integrally formed. A width of the connecting element is same as a width of the second support body.

Furthermore, the first support body and the second support body are made of plastic materials. The reflector is an acrylic plate, glasses, or silica gel sheet; the convex lens is made of glass, acrylic, or plastic materials.

Furthermore, the fixed included angle between reflector and the convex lens is less than or equal to 55 degree.

Furthermore, the mechanical transmission regulator comprises a gear drive structure.

Smart glasses comprise the optical apparatus for near-eyes display as described above and a head band that is used to fix the optical apparatus for near-eyes display. A fixed connecting block is disposed between the head band and the optical apparatus for near-eyes display.

Furthermore, the optical apparatus for near-eyes display can be disposed on a left side of the head band or a right side of the head band. It should be understood that the optical apparatus for near-eyes display can be disposed on the left side of the head band and the right side of the head band at the same time.

Compared with the prior art, the present disclosure uses that the optical apparatus for near-eyes display comprises the support body, the display screen disposed in the support body, the convex lens and the reflector reflecting light. The light of the display screen pass through the convex lens and are amplified by the convex lens. The amplified light enters into the reflector and is reflected to human eyes. Namely, the present disclosure uses simpler method with lower cost to achieve optical structure of the near-eyes display system, which can directly process production without opening mold. The production process is very simple, at the same time, position of the convex lens can be adjusted according to myopia degree of the glasses of a user, so that the image can be clearly saw, the structure is simple, and the cost is low, further being convenient to use.

### BRIEF DESCRIPTION OF DRAWINGS

FIG. 1 is a three-dimensional structural diagram of an optical apparatus for near-eyes display of the present disclosure.

FIG. 2 is a three-dimensional structural diagram of smart glasses corresponding to the optical apparatus for near-eyes display of the present disclosure.

FIG. 3 is a three-dimensional structural diagram of other perspective of the optical apparatus for near-eyes display of the present disclosure.

FIG. 4 is a cross-section structural diagram of a first support body in the optical apparatus for near-eyes display of the present disclosure.

### DETAILED DESCRIPTION OF PREFERRED EMBODIMENTS

In order to clearly describe aim, technical scheme, and advantage of the present disclosure, the following will briefly introduce the drawings for the embodiment. It should be understood, the following description is only a few embodiments, the used directional terms are intended to illustrate, but not to limit, the present invention.

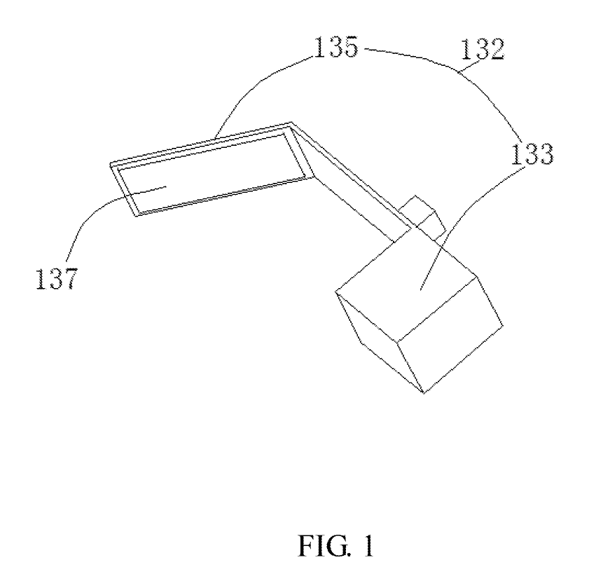

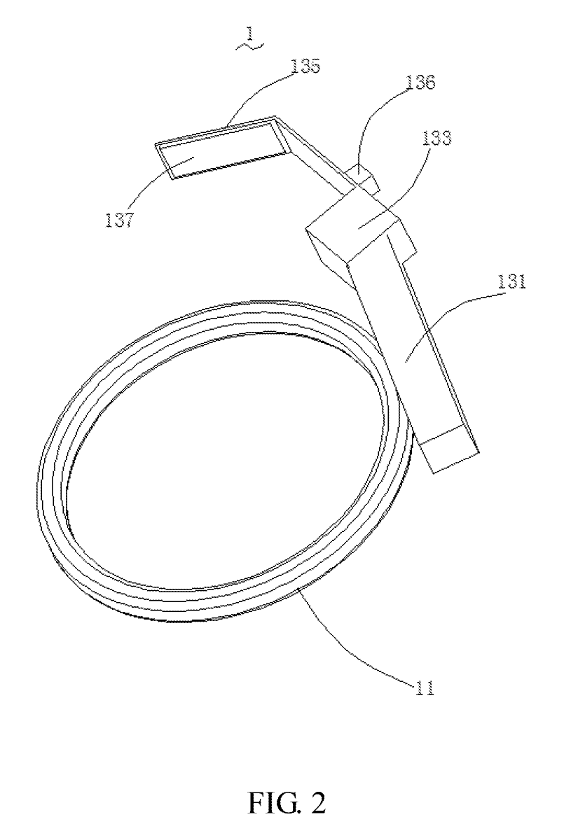

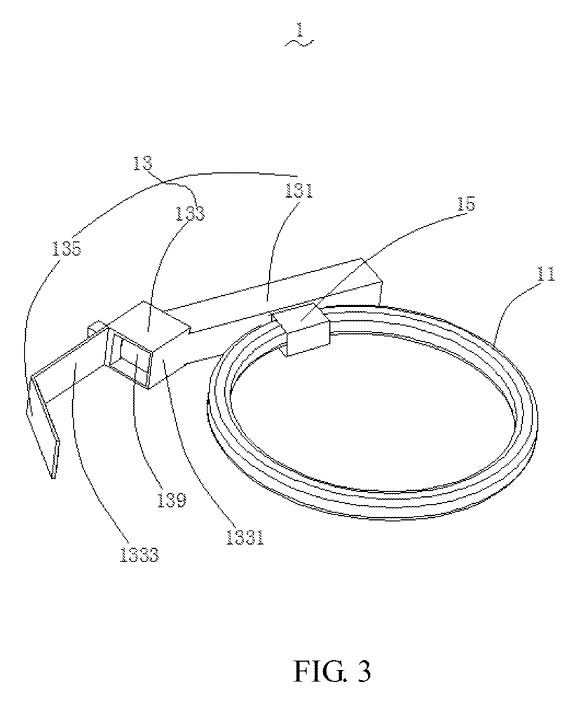

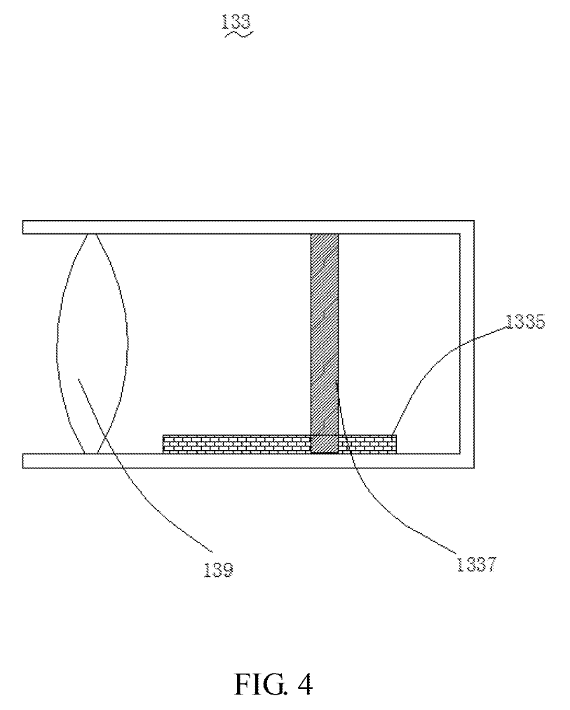

As shown in FIG. 1 to FIG. 4, the present disclosure provides an optical apparatus 13 for near-eyes display comprises a support body 132, a display screen 1337 disposed in the support body 132, a convex lens 139, and a reflector 137 reflecting light. The light of the display screen 1337 passes through the convex lens 139 and are amplified by the convex lens 139. The amplified light enters into the reflector 137 and is reflected to human eyes. The convex lens 139 is disposed between the reflector 137 and the display screen 1337. The reflector 137 and the convex lens 139 form a fixed included angle and are not parallel to each other. The reflector 137 and the convex lens 139 are at a same axis position.

The optical apparatus 13 for near-eyes display further comprises a controller and a power source. The display screen 1337 is electrically connected with the controller and the power source.

The present disclosure uses that the optical apparatus 13 for near-eyes display comprises the support body 132, the display screen 1337 disposed in the support body 132, the convex lens 139 and the reflector 137 reflecting light. The light of the display screen 1337 passes through the convex lens 139 and are amplified by the convex lens 139. The amplified light enters into the reflector 137 and is reflected to human eyes. Namely, the present disclosure uses simpler method with lower cost to achieve optical structure of the near-eyes display system, which can directly process production without opening mold. The production process is very simple, at the same time, position of the convex lens 139 can be adjusted according to myopia degree of the glasses of a user, so that the image can be clearly saw, the structure is simple, and the cost is low, further being convenient to use.

The support body 132 comprises a first support body 133 and a second support body 135, where the first support body 133 and the second support body 135 are bent at an angle. The reflector 137 is disposed on the second support body 135 and the convex lens 139 and the display screen 1337 are disposed in the first support body 133. The reflector 137 is parallel to the second support body 135. The support body further comprises a control box 131. The controller and the power source are disposed in the control box 131. The control box 131 is connected with the first support body 133. The structural design is reasonable, which ensures stability of the reflector 137 and the convex lens 139, and improves working life.

The display screen 1337 is parallel to the convex lens 139, and the display screen 1337 and the convex lens 139 are perpendicular to the first support body 133.

A mechanical transmission regulator 1335 disposed between the display screen 1337 and the convex lens 139 is used to adjust distance between the display screen 1337 and the convex lens 139, which makes the products adopt to more application environments

An angle regulator 136 is disposed between the first support body 133 and the second support body 135 and is used to adjust the angle between the first support body 133 and the second support body 135, which is easy to adjust, and has wider range of application.

The first support body 133 comprises a storage box 1331 containing the convex lens 139 and the display screen 1337, and a connecting element 1333 connected with the second support body 135. The connecting element 1333 and the storage box 1331 are integrally formed. A width of the connecting element 1333 is same as a width of the second support body 135.

The first support body 133 and the second support body 135 are made of plastic materials. The reflector 137 is an acrylic plate, glasses or silica gel sheet. The convex lens 139 is made of glass, acrylic, or plastic materials.

The fixed included angle between reflector 137 and the convex lens 139 is less than or equal to 55 degree, which is convenient to obtain good watching experience.

The mechanical transmission regulator 1335 comprises a gear drive structure, which has a long working life.

Smart glasses 1 comprise the optical apparatus 13 for near-eyes display as described above and a head band that is used to fix the optical apparatus 13 for near-eyes display. A fixed connecting block 15 is disposed between the head band 11 and the optical apparatus 13 for near-eyes display.

The optical apparatus 13 for near-eyes display can be disposed on a left side of the head band 11 or a right side of the head band 11. It should be understood that the optical apparatus 13 for near-eyes display can be disposed on the left side of the head band 11 and the right side of the head band 11 at the same time.

The control box 131 comprises a control button electrically connected with the controller, and a storage storing play message. Or the control box 131 comprises a wireless network process unit, which is in communication interconnection with an external network data.

Compared with the prior art, the present disclosure uses that the optical apparatus 13 for near-eyes display comprises the support body 132, the display screen 1337 disposed in the support body, the convex lens 139 and the reflector 137 reflecting light. The light of the display screen 1337 passes through the convex lens 139 and are amplified by the convex lens 139. The amplified light enters into the reflector 137 and is reflected to human eyes. Namely, the present disclosure uses simpler method with lower cost to achieve optical structure of the near-eyes display system, which can directly process production without opening mold. The production process is very simple, at the same time, position of the convex lens 139 can be adjusted according to myopia degree of the glasses of a user, so that the image can be clearly saw, the structure is simple, and the cost is low, further being convenient to use.

The present disclosure uses specific embodiments to describe the principle and implementation way of the present disclosure. It should be understood that the present disclosure has been described with reference to certain preferred and alternative embodiments which are intended to be exemplary only and do not limit the full scope of the present disclosure as set forth in the appended claims.

What is claimed is:

1. An optical apparatus for near-eyes display, comprising:
a support body;
a display screen disposed in the support body;
a convex lens; and
a reflector reflecting light;
wherein the light of the display screen pass through the convex lens and are amplified by the convex lens; the amplified light enters into the reflector and is reflected to human eyes; the convex lens is disposed between the reflector and the display screen; the reflector and the convex lens form a fixed included angle and are not parallel to each other; the reflector and the convex lens are at a same axis position.

2. The optical apparatus for near-eyes display as claimed in claim 1, wherein the support body comprises a first support body and a second support body; wherein the first support body and the second support body are bent at an angle; the reflector is disposed on the second support body, and the convex lens and the display screen are disposed in the first support body; the reflector is parallel to the second support body.

3. The optical apparatus for near-eyes display as claimed in claim 1, wherein the display screen is parallel to the convex lens; the display screen and the convex lens are perpendicular to the first support body.

4. The optical apparatus for near-eyes display as claimed in claim 1, wherein a mechanical transmission regulator is disposed between the display screen and the convex lens; the mechanical transmission regulator adjusts distance between the display screen and the convex lens.

5. The optical apparatus for near-eyes display as claimed in claim 2, wherein an angle regulator is disposed between the first support body and the second support body, and adjusts the angle between the first support body and the second support body.

6. The optical apparatus for near-eyes display as claimed in claim 2, wherein the first support body comprises a storage box containing the convex lens and the display screen, and a connecting element connected with the second support body; the connecting element and the storage box are integrally formed; a width of the connecting element is same as a width of the second support body.

7. The optical apparatus for near-eyes display as claimed in claim 1, wherein the first support body and the second support body are made of plastic materials; the reflector is an acrylic plate, glasses, or silica gel sheet; the convex lens is made of glass, acrylic, or plastic materials.

8. The optical apparatus for near-eyes display as claimed in claim 1, wherein the fixed included angle between reflector and the convex lens is less than or equal to 55 degrees.

9. The optical apparatus for near-eyes display as claimed in claim 4, wherein the mechanical transmission regulator comprises a gear drive structure.

10. The optical apparatus for near-eyes display as claimed in claim 2, wherein a mechanical transmission regulator is disposed between the display screen and the convex lens; the mechanical transmission regulator adjusts distance between the display screen and the convex lens.

11. The optical apparatus for near-eyes display as claimed in claim 3, wherein a mechanical transmission regulator is disposed between the display screen and the convex lens; the mechanical transmission regulator adjusts distance between the display screen and the convex lens.

12. The optical apparatus for near-eyes display as claimed in claim 5, wherein the first support body comprises a storage box containing the convex lens and the display screen, and a connecting element connected with the second support body; the connecting element and the storage box are integrally formed; a width of the connecting element is same as a width of the second support body.
